(19) United States
(12) Patent Application Publication
(10) Pub. No.: US 2024/0008960 A1
(43) Pub. Date: Jan. 11, 2024

(54) REZAA RINGS

(71) Applicant: Muhammad Raza, Jamaica, NY (US)

(72) Inventor: Muhammad Raza, Jamaica, NY (US)

(73) Assignee: Muhammad Raza, Jamaica, NY (US)

(21) Appl. No.: 18/346,210

(22) Filed: Jul. 1, 2023

(51) Int. Cl. A61C 8/00

(52) U.S. Cl. CPC A61C 8/0045; A61C 2008/0046

(57) ABSTRACT

In this invention one or more intermittent turned/smooth/machined/hybrid sub-collar/s (Rezaa Ring/s) feature/s are added. This can be done around any shape, size or type of dental implant. The sub-collars (Reza Rings) can be added at any point or location below the platform of a dental implant. The purpose is to halt or slow down the progression of peri-implantitis. In addition the prognosis of the infected dental implant is improved due to the presence of this added smooth surface; be it either merely due to the presence of this smooth surface or as the result of treatment in the presence of this smooth surface. Its appearance on a radiograph also serves as a demarcation point for both the clinicians and patients alike.

### TECHNICAL FIELD OF INVENTION

Generally the invention relates to the field of dental implantology, periodontics and oral surgery. It is more specific to dental implants; it has turned/smooth/machined/hybrid sub-collar/s (Rezaa Ring/s) feature/s 786, 786a, 786b, 786c useful for demarcation, halting/slowing the progression of peri-implantitis and allowing dental implants treated for peri-implantitis to have a better prognosis.

### BACKGROUND OF INVENTION

In this modern era of dentistry when a missing tooth needs to be replaced amongst the several options available dental implants are the top choice. Patients are spending enormous amounts of money to have dental implants placed. They don't realize that so many factors can contribute to problems with dental implants. Some backup measures need to be taken to allow dental implants to have a higher success and survival rate; minimizing not just peri-implantitis initiation but progression as well.

Although the success and survival rate for dental implants is very high; the prevalence of peri-implantitis is recently going up to 20% or more according to studies. Peri-implantitis is an infectious disease, which may be characterized by supporting bone loss, bleeding on probing, increased peri-implant pocket probing depths, possible mucosal recession and/or suppuration.

Peri-implantitis may happen as a result of many factors. Many studies have shown that at the implant level; the implant design and surface characteristics do have an impact on the initiation and progression of peri-implantitis as well as on the prognosis of peri-implantitis upon treatment.

Several experimental animal studies have been used to induce peri-implantitis lesions with ligatures. Progression of peri-implantitis was observed especially more so around dental implants with rough surfaces as compared to machined surfaces.

Once bone loss starts to progress around a dental implant, we have no measure to see if or when bone loss progression will stop. In the majority of the cases, progression of the bone loss cannot be halted without intervention.

Dental implant designs generally have a tapered or straight parallel walled body from coronal to apical with threads similar to a screw shape. The surface is moderately rough. In the previous decade a hybrid coronal aspect has been introduced with the goal of having less bone loss around the dental implant when exposed.

### SUMMARY OF THE INVENTION

The present invention is directed to the addition of a unique feature to all types/surfaces of dental implants be it; bone level or tissue level, tapered or cylindrical, reverse tapered, hybrid concept, straight or angled bore dental implants etc. It incorporates a turned/smooth/machined/hybrid sub-collar/s (Rezaa Ring/s) feature/s at one or more intermittent locations on the dental implant. In this particular disclosure one to three intermittent sub-collars are demonstrated only; although more can be added. The first Sub-collar (Rezaa Ring) is several millimeters below the platform, the second Sub-collar (Rezaa Ring) is approximately midlevel of the dental implant and the third Sub-collar (Rezaa Ring) is several millimeters above the apex of the dental implant; measuring from the apex back. The purpose is to either halt or slow down the progression of Peri-implantitis. In addition, the prognosis of treatment is improved due to the presence of a smooth non threaded surface.

### BRIEF DESCRIPTION OF THE DRAWINGS

The benefits and understanding of this new invention will be clearer reading the description below and cross referencing with the drawings.

FIG. 1A is a perspective view of a tapered dental implant in accordance with the present invention disclosure in particular the addition of one turned/smooth/machined/hybrid sub-collar (Rezaa Ring) feature that has a diameter smaller than the diameter of the crests of the threads above and below the sub-collar.

FIG. 1B is a cross sectional view of the dental implant shown in FIG. 1A, where the sub-collar has an indentation inwards from the crest of the thread above and below the sub-collar.

FIG. 1C is a perspective view of a tapered dental implant in accordance with the present invention disclosure in particular the addition of one turned/smooth/machined/hybrid sub-collar (Rezaa Ring) feature where the diameter of the sub-collar is the same (in a cylindrical type of dental implant) or similar (in a tapered type of dental implant) to the diameter of the crest of the thread above and below the sub-collar.

FIG. 1D is a cross sectional view of the dental implant shown in FIG. 1C where the sub-collar has no indentation rather it is in line with the crest of the thread above and below the sub-collar.

FIG. 2A is a perspective view of a tapered dental implant in accordance with the present invention disclosure in particular the addition of multiple intermittent turned/smooth/machined/hybrid sub collars (Rezaa Rings) features that have a diameter lesser than the diameter of the crest of the threads above and below the sub-collars.

FIG. 2B is a cross sectional view of the dental implant shown in FIG. 2A where the sub-collars have indentations inward from the crest of the threads above and below the sub-collars.

FIG. 2C is a perspective view of a tapered dental implant in accordance with the present invention disclosure in particularly the addition of multiple intermittent turned/smooth/machined/hybrid sub-collars (Rezaa Rings) features where the diameter of the sub-collars are the same (in a cylindrical type of dental implant) or similar (in a tapered type of dental implant) to the diameter of the crests of the thread above and below the sub-collars.

FIG. 2D is a cross sectional view of the dental implant shown in FIG. 2C where the sub-collars have no indentations rather are in line with the crest of the threads above and below the sub-collars.

FIG. 3A is a perspective view of a tapered tissue level dental implant in accordance with the present invention disclosure with not only the addition of multiple intermittent turned/smooth/machined/hybrid sub-collars (Rezaa Rings) features; but a machined collar being present at the top most of the dental implant; above the rough portion of the body as it is a tissue level implant. Again, it is to be noted that the turned/smooth/machined/hybrid sub collars (Rezaa Rings) features that have diameters lesser than the diameter of the crest of the threads above and below the sub-collars.

FIG. 3B is a cross sectional view of the dental implant shown in FIG. 3A.

FIG. 3C is a perspective view of a tapered tissue level dental implant in accordance with the present invention disclosure with not only the addition of multiple intermittent turned/smooth/machined/hybrid sub collars (Rezaa Rings) features; but a machined collar being present above the rough portion of the body as it is a tissue level implant. The difference to be noted is that the turned/smooth/machined/hybrid sub collars (Rezaa Rings) features have a diameter the same (in a cylindrical type of dental implant) or similar (in a tapered type of dental implant) to the diameter of the crest of the thread above and below the sub-collars.

FIG. 3D is a cross sectional view of the dental implant shown in FIG. 3C where the sub-collars have no indentations rather are in line with the crest of the threads above and below.

FIG. 4A is a cross sectional view of the mandible with the dental implant placed in the prepared osteotomy. It is to be noted that the intermittent turned/smooth/machined/hybrid sub collars (Rezaa Rings) features have indentations inwards from the crest of the threads above and below the sub-collars.

FIG. 4B is a cross sectional view of the mandible with the dental implant placed in the prepared osteotomy. The intermittent turned/smooth/machined/hybrid sub collars (Rezaa Rings) features that have a diameter the same or similar to the diameter of the crest of the threads above and below the sub-collars.

FIG. 5 is a schematic applied view of the embodiment of the present invention, illustrating this specific dental implant disclosure with its sub-collar features installed in the bone in relation to the sinus floor and inferior alveolar nerve.

FIG. 6A is a radiographic view of a cylindrical dental implant in accordance with the present invention disclosure in particular with the presence of multiple intermittent turned/smooth/machined/hybrid sub collars (Rezaa Rings) features visible on the radiograph. The intermittent turned/smooth/machined/hybrid sub collars (Rezaa Rings) features have a diameter smaller than the diameter of the crests of the threads above and below the sub-collars of this cylindrical type of dental implant.

FIG. 6B is a radiographic view of a cylindrical dental implant in accordance with the present invention disclosure in particular with the presence of multiple intermittent turned/smooth/machined/hybrid sub collars (Rezaa Rings) visible on the radiograph. It is to be noted that the intermittent turned/smooth/machined/hybrid sub collars (Rezaa Rings) features have a diameter the same as the the diameter of the crest of the threads above and below the sub-collars.

This particular disclosure is demonstrated in the figures and explained throughout in the description. However, it can have many changes, alternative forms and modifications; specific implementations have been shown via some examples in the drawings and are described in detail in the context. It should be understood, however, that the present disclosure is not intended to be only limited to the particular forms disclosed. Rather, the present disclosure is to cover all variations, similarities, and alternatives falling within the confines of the present disclosure as defined by the claims.

The locations of the intermittent turned/smooth/machined/hybrid sub-collar/s (Rezaa Ring/s) feature can be at any location from the platform down. However, in this present invention disclosure of a 10 mm dental implant; it is placed at the following specific locations:
1^{st} Sub-collar—3.5 mm below the platform
2^{nd} Sub-collar—5 mm below the platform
3^{rd} Sub-collar—3.5 mm above the apex, measuring from the apex back.

In addition, the height of each sub-collar is 1 mm in this disclosure. This can also be very variable from a minimum of 0.1 to 1.5 mm or greater. The most common length however is 0.5 mm.

### DETAILED DESCRIPTION

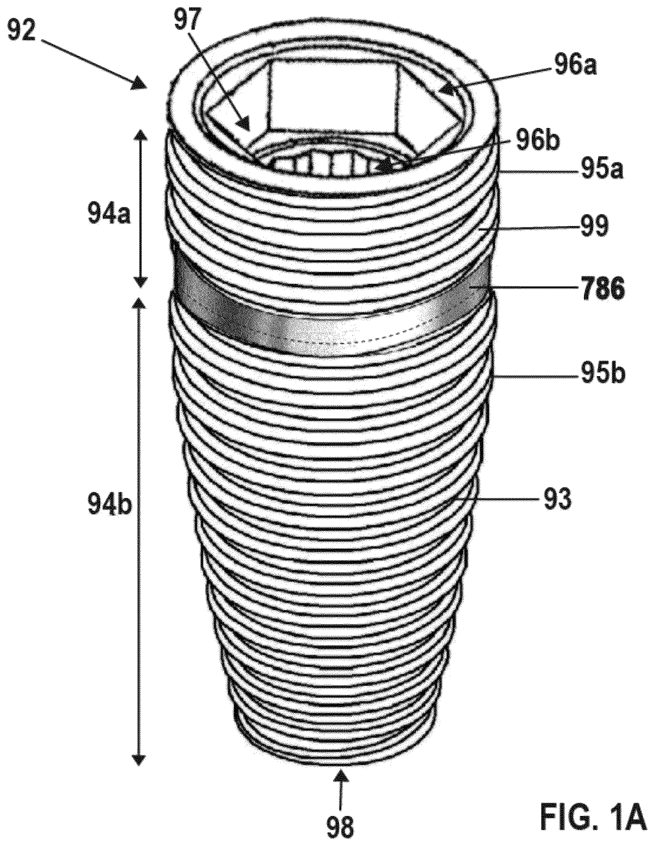

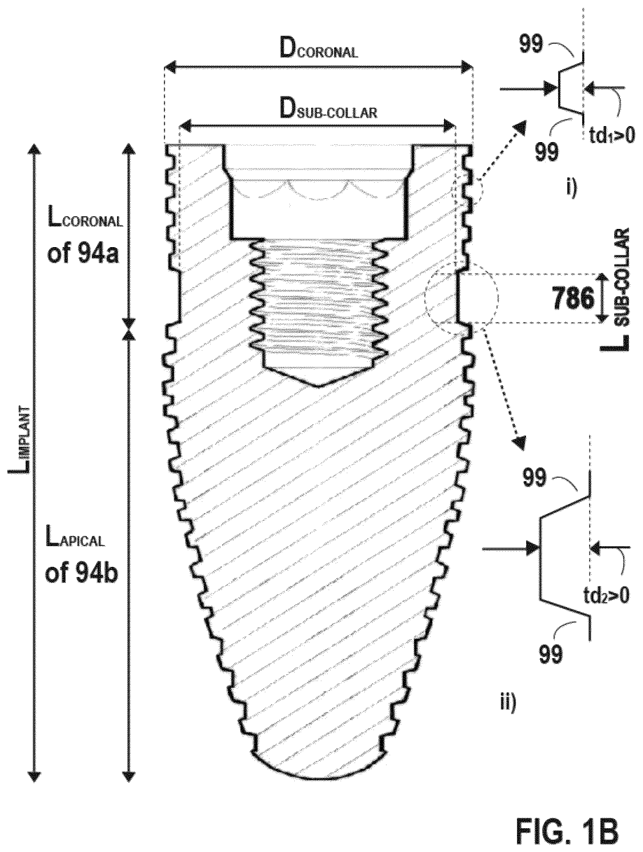

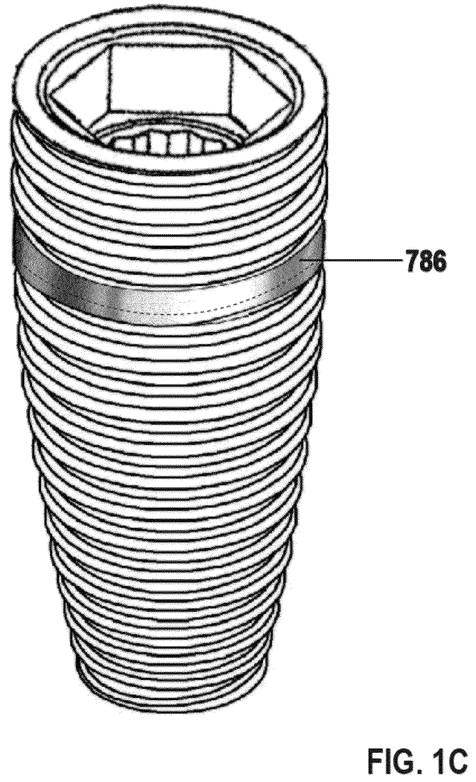

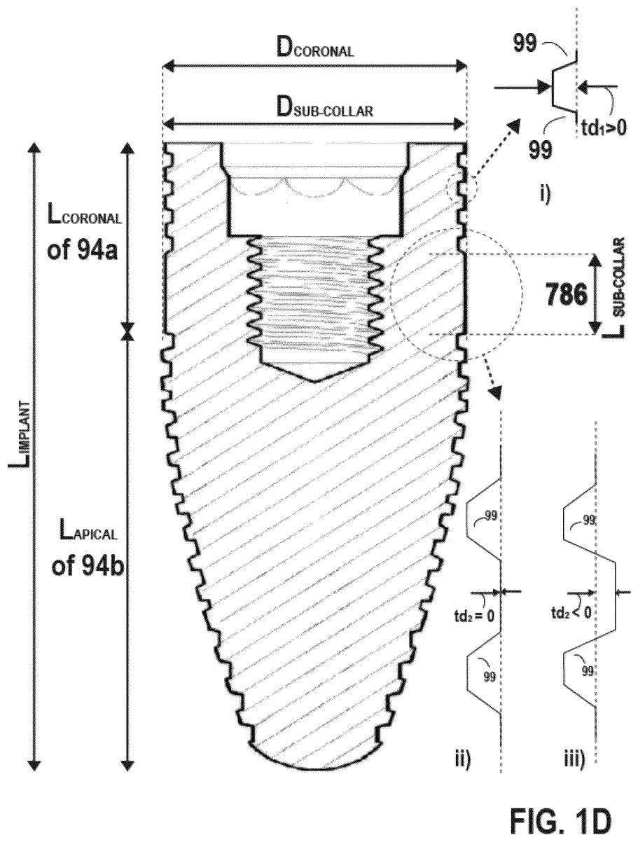

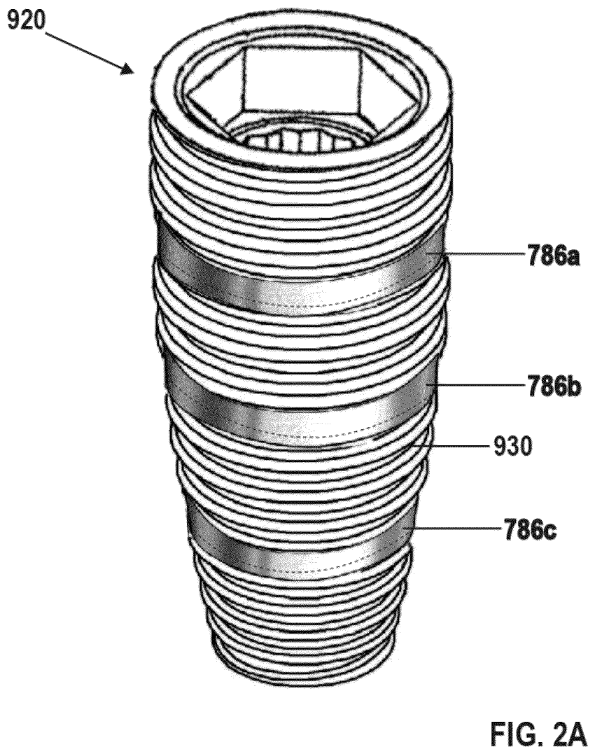

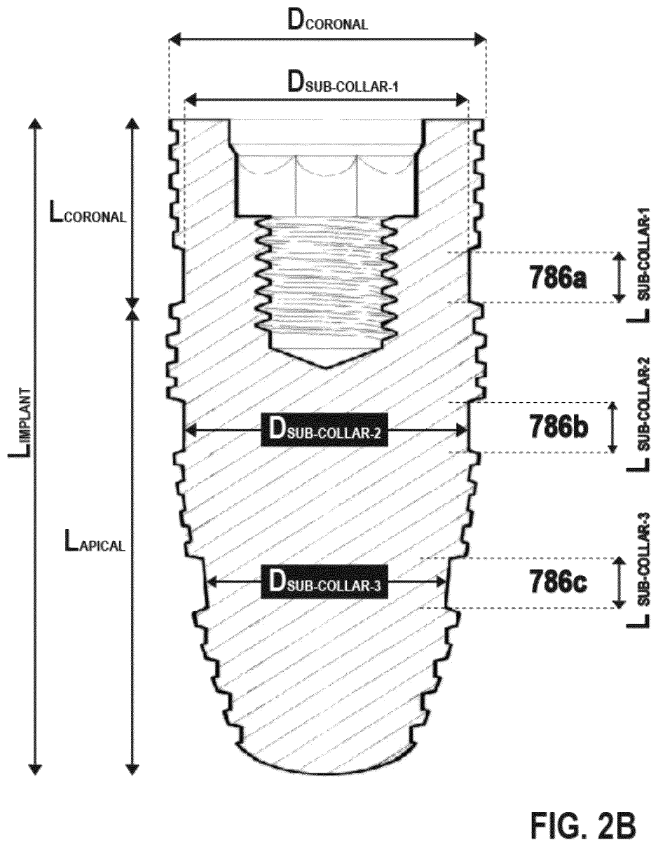

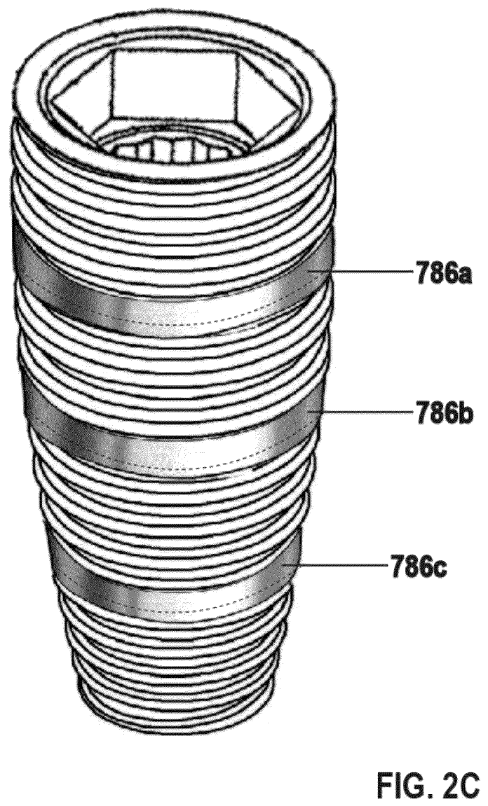

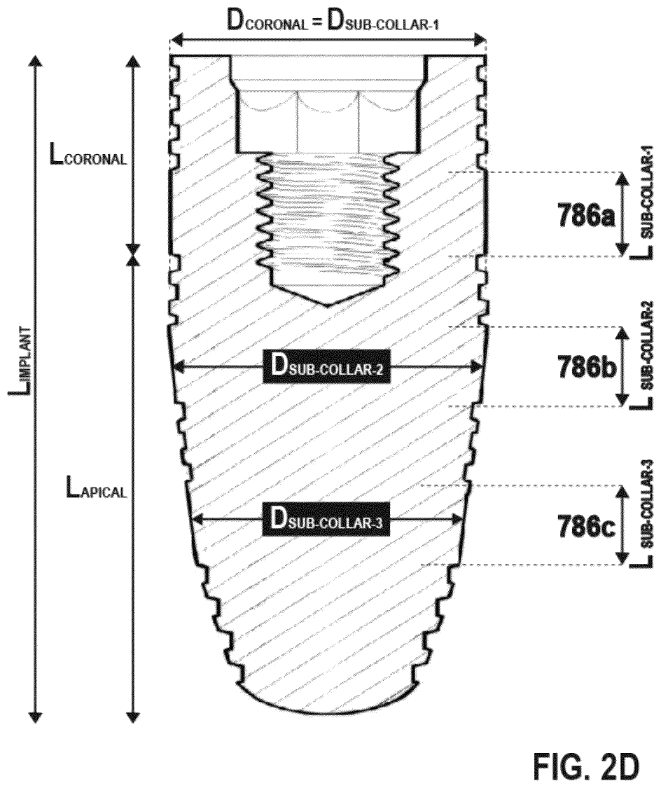

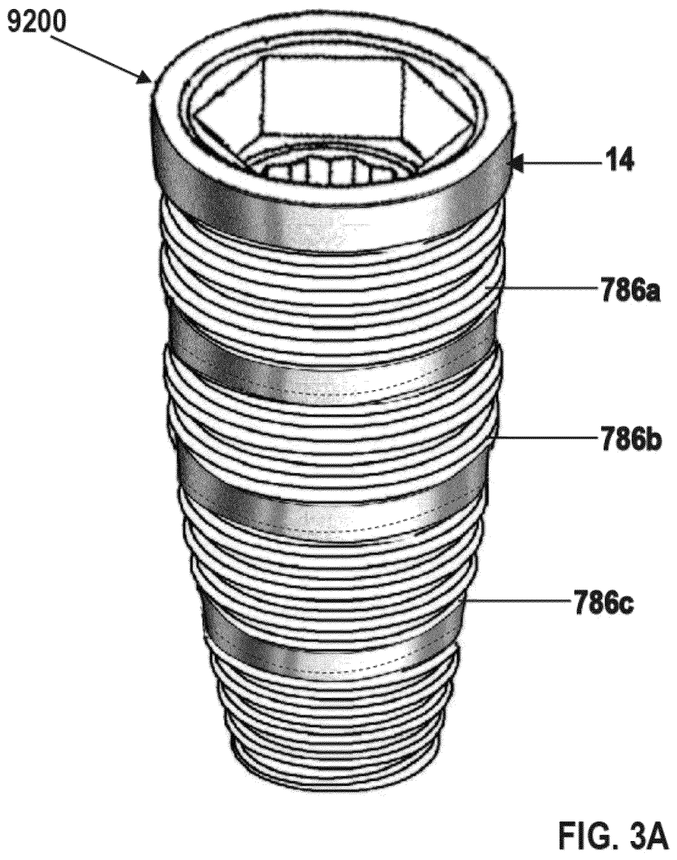

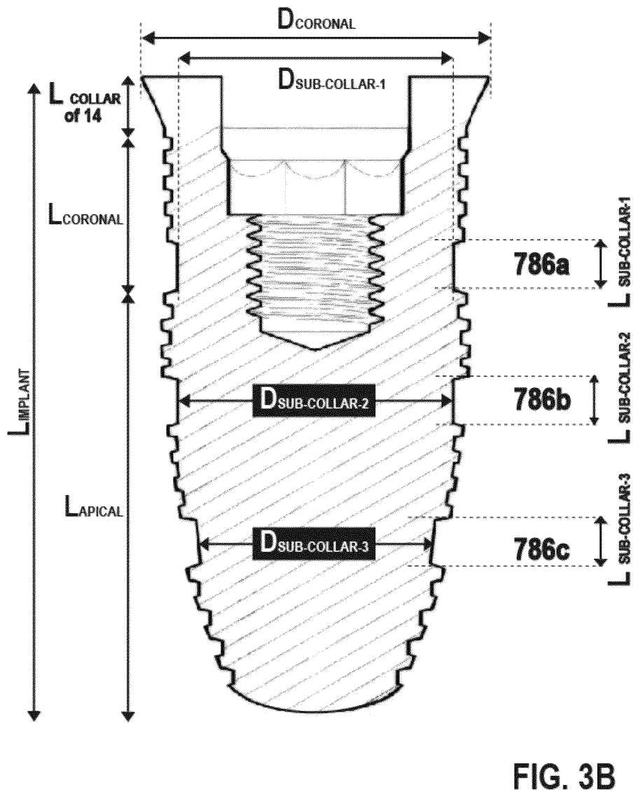

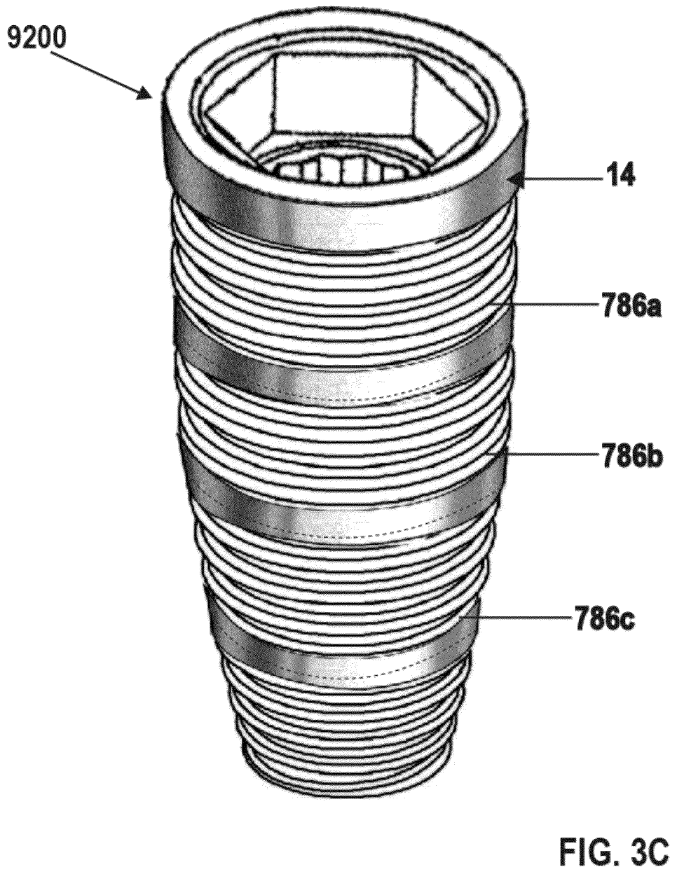

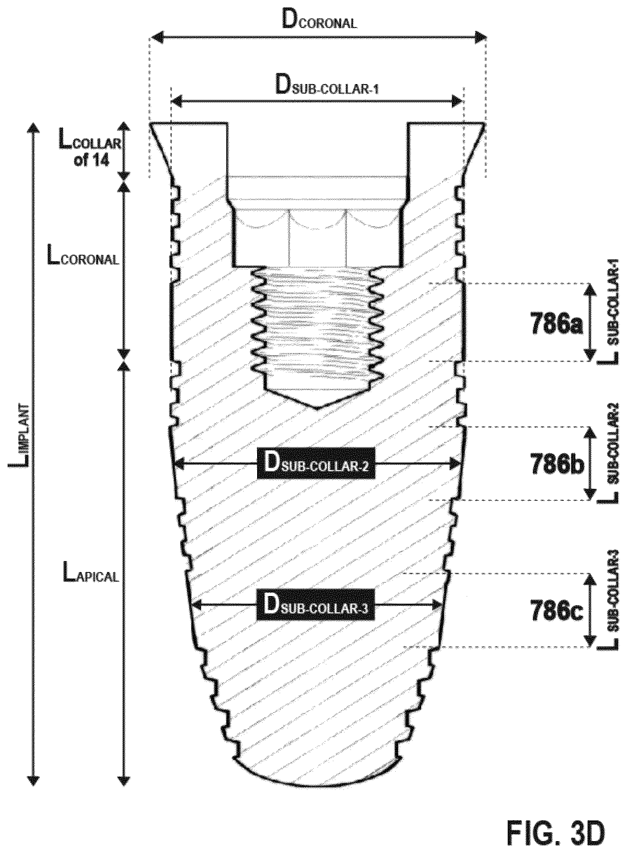

For ease of demonstration in this present disclosure; a tapered straight bore (not angled) dental implant is taken into account. However, it is to be noted that this invention is for all types of dental implants be it angled or any other type. In FIGS. 1A, 1B, 1C and 1D; a tapered dental implant 92 is shown in accordance with a first embodiment of the present invention. In these figures one sub-collar is demonstrated either indented inwards or in line with the crest of the threads above and below it. The description below applies to all the figures (FIGS. 2, 3, 4, 5 and 6), however for ease of understanding FIG. 1 is described in detail. For labeling compared to FIG. 1 (e.g. 92) an additional zero is added to all the components in FIG. 2 (e.g. 920) and a second zero is added in all the FIG. 3 components (e.g. 9200). When only one sub-collar is present its labeled as 786 (all the FIG. 1s); when multiple are present it is labeled as 786a, 786b and 786c (all remaining figures).

The dental implant 92 comprises of a body 93. The body 93 has a coronal part 94a and an apical part 94b. The body 93 has an outer surface 95 (coronal 95a and apical 95b). In addition the dental implant has an interior bore 96a and a non-rotational feature 97. The interior bore 96a of the dental implant 92 has a threaded part 96b into which coverscrew or an abutment is screwed in the dental implant 92.

The non-rotational feature 97 shown is a hexagonal; although it can also be of variable other shapes. This meets non-rotationally with a corresponding non-rotational feature of an abutment in a non-rotational fashion. In this tapered form of dental implant the apical part 94b of the body 93 tapers inward towards a lowest end 98 of the apical part 94b of the dental implant 92. The outer diameter decreases along the taper in an apical direction towards the lowermost end 98 of the apical part 94b. Alternatively, other than the dental implant being tapered; it can also be non-tapered, straight, combination or even convex. In addition it may be a bone level, tissue level, and/or a combination of a straight and curved taper. In addition, the exterior surface 95b of the apical part 94b can form a curved taper (e.g. convex curved taper) and/or a combination of a straight and curved taper. Also, the dental implant may be a straight bore or an angled bore dental implant.

The body 93 of a dental implant 92 has threads 99 from the coronal to the apical part of the implant except at certain sites where these intermittent non-threaded turned/smooth/machined/hybrid sub collar/s (Rezaa Ring/s) 786, 786a, 786b and 786c features are present.

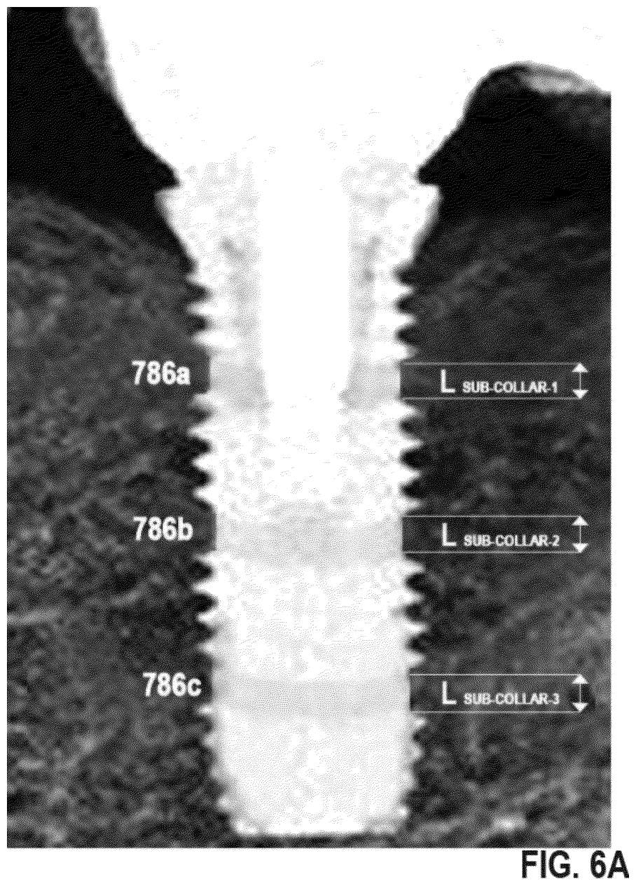

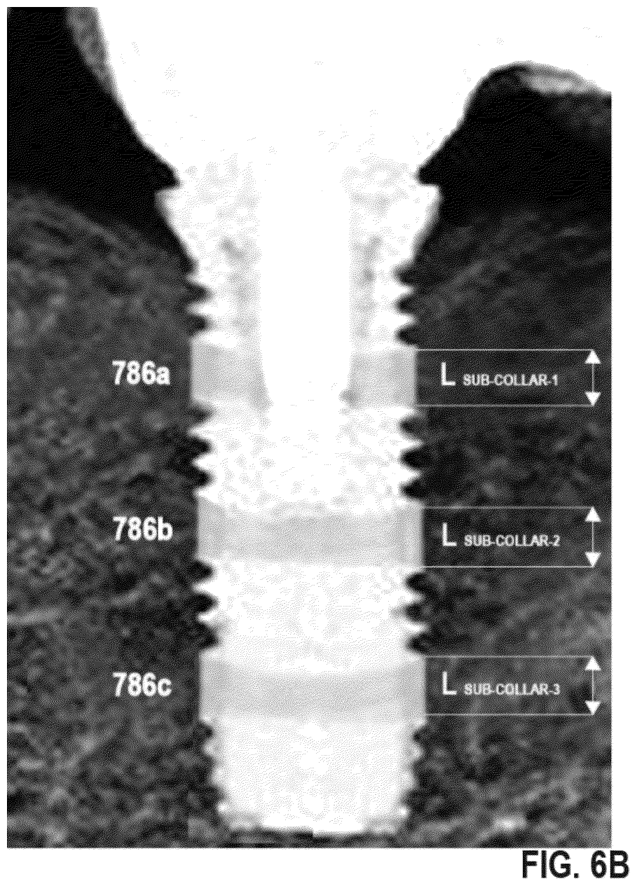

In FIG. 1B/1D the coronal most part of the body of the dental implant has an outer diameter, D_{CORONAL}. The coronal part 94a of the body 93 has within it the turned/smooth/machined/hybrid sub collar/s (Rezaa Ring/s) feature 786 (and 786a, 786b and 786c in FIGS. 2, 3, 4, 5 and 6). This is a smooth surface with either no indentation (FIG. 1D) or an inward indentation (FIG. 1B). The turned/smooth/machined/hybrid sub-collar/s (Rezaa Ring/s) feature/s 786, 786a, 786b and 786c aids in halting (allows the bone to remain stable at the junction of the rough and machined surface, immediately below the sub-collar) and eventually slowing the progression of peri-implantitis, allowing time for the clinician to treat the peri-implantitis. The turned/smooth/machined/hybrid sub collar (Rezaa Ring) features 786 (and 786a, 786b and 786c in FIGS. 2, 3, 4, 5 and 6); have a smooth surface to the level of the crest of the threads above and below it with no depth or with a depth (an inward indentation). In both situations it is visible on the radiograph due to the crest of the threads above an below it (FIGS. 6A and 6B). This radiographic appearance will provide a guideline and ease for the clinician to diagnose and eventually to either treat or refer to treat by another provider. As such, the dental implant 92 with the intermittent turned/smooth/machined/hybrid sub-collar (Rezaa Ring) feature 786 (and 786a, 786b and 786c in FIGS. 2, 3, 4, 5 and 6) should be placed in all patients as a replacement to all other dental implants without such intermittent turned/smooth/machined/hybrid sub-collar/s (Rezaa Ring/s) 786, 786a, 786b and 786c features. In situations where clinicians for some reason want to limit its use to certain patients; they can to patients that are high risk for peri-implantitis (Smokers, History of Periodontal disease, History of Peri-Implantitis, Diabetes, Patients with poor oral hygiene, etc.). Although it should be made clear that dental implants with these sub collars do not give the license to a clinician to place them in high risk patients; rather the high risk factors should be controlled.

The turned/smooth/machined/hybrid sub-collar/s (Rezaa Ring/s) feature/s 786, 786a, 786b and 786c have a very minimal roughness to allow osseointegration but at the same time function as proposed in the present disclosure. Clinically looking at it; it is visible as a smooth surface; similar to a healing abutment (Sₐ 0.1-0.3 μm), the difference being that it is osseointegratable with a surface roughness of (±0.5 μm) that is similar to traditional machined surface dental implants. Dental implants are roughly divided into three different types of surface roughness (Sₐ): machined/minimal (±0.5 μm), moderate (1.0-2.0 μm), and rough (>2.0 μm). Generally, rougher implant surfaces have greater bone-to-implant contact. As mentioned above typical Sₐ values for machined surfaces are 0.3-1.0 μm. The surface oxide consists of a 2-10 nm thick mostly amorphous layer of TiO2.

One very important scenario that will be commonly utilized within the intermittent turned/smooth/machined/hybrid sub-collars (Rezaa Rings) features 786, 786a, 786b and 786c is a combination of machined (Sₐ 0.3-1.0 μm) and polished surfaces (Sₐ 0.1-0.3 μm). The subcollar will be divided into the top ⅔^{rds} that will be the machined surface with an Sₐ value between 0.3-1.0 μm and a lower ⅓^{rd} that will be a polished surface with an Sₐ value between 0.1-0.3 μm (demonstrated by the dotted lines in FIGS. 1A, 1C, 2A, 2C, 3A and 3C). Clinically the sub-collar will look the same throughout but transition zone will be visible under an electron microscope. This will provide that sudden halt of bone progression right below the non osseointegratable lower ⅓^{rd} of the sub-collar/s. By dividing each sub-collar into an upper ⅔^{rd} and a lower ⅓^{rd} osseointegration is not compromised as the machined surfaces are promoting bone growth. In a 1 mm sub-collar it can be divided as 0.7 mm coronal ⅓^{rd} of sub-collar and 0.3 mm apical ⅓^{rd} of the sub-collar. Similarly in a 0.5 mm sub-collar top ⅔^{rd} which is 0.35 and lower ⅓^{rd} which is 0.15. However it is to be noted that it is variable and it is not necessary that the division is b/w ⅔^{rd} and ⅓^{rd}; any ratio feasible can be taken.

The turned/smooth/machined/hybrid sub-collar (Rezaa Ring) feature 786, 786a, 786b and 786c extends 360 degrees around the coronal part 94a of the body 92. The turned/smooth/machined/hybrid sub-collar (Rezaa Ring) feature 786, 786a, 786b and 786c is generally symmetrical about the central axis X_{central} of the dental implant 92.

In one scenario the turned/smooth/machined/hybrid sub-collar (Rezaa Ring) feature 786, 786a, 786b and 786c in the coronal part 94a has a relatively slightly narrower outer diameter D_{SUBCOLLAR} (FIGS. 1A, 1B, 2A, 2B, 3A, 3B, 4A, 5 and 6A), which allows for bone ingrowth towards the turned/smooth/machined/hybrid sub-collar/s (Rezaa Ring/s) feature/s 786, 786a, 786b and 786c. This would also allow for a relatively larger initial gap between the outer surface 95a of the coronal part 94a and the wall of the osteotomy prepared into which the dental implant 92 is installed; hence the blood clot and eventually the bone fill occurs. To some extent this may provide a locking effect and a thicker buccal plate. On the other hand in another scenario the sub-collar/s have the same diameter as the diameter of the crest of the threads above and below it (FIGS. 1C, 1D, 2C, 2D, 3C, 3D, 4B, and 6B). In other words the sub-collars will not create an indentation inwards. In the last scenario the turned/smooth/machined/hybrid sub-collar (Rezaa Ring) feature 786, 786a, 786b and 786c are slightly larger than the diameter of the crests of threads above and below.

The coronal part 94a has a length L_{CORONAL} from the platform to right below the turned/smooth/machined/hybrid sub-collar (Rezaa Ring) feature 786 or 786a. This length L_{CORONAL} can range from an average of ≤1.5 to ≥to 5.5 millimeters; depending on the location of the sub-collar feature 786, 786a. In this implementation the length L_{CORONAL} of the coronal part 94a is taken as 4.5 mm; the sub-collar (Reza Ring) is 1 mm in length in this implementation hence it is starting from 3.5 to 4.5 mm. The coronal most sub-collar feature 786, 786a is not very close to the platform as bone stability is the goal from the platform down. If the sub-collar 786, 786a begins too close to the platform, this may cause the bone to resorb quicker to immediately below the sub-collar during remodeling or other reasons (e.g. placement, angulation, etc.), which in essence is only the backup goal if peri-implantitis initiates.

The non-threaded turned/smooth/machined/hybrid sub-collar (Rezaa Ring) feature 786 has a distance of L_{SUB-COLLAR}. For this specific present disclosure, the turned/smooth/machined/hybrid sub-collar (Rezaa Ring) feature 786, 786a starts 3.5 mm below the platform with a length of L_{SUB-COLLAR}. For this specific disclosure a length of 1 mm is considered which otherwise can range from 0.1-2.5 mm. In some implementations the length L_{SUB-COLLAR} of each turned/smooth/machined/hybrid sub-collar (Rezaa Ring) feature 786, 786a, 786b and 786c is about 5 to 30 percent of the overall length L_{IMPLANT} of the dental implant 92. In some other implementations it may be less than 5 percent or greater than 30 percent of the overall length L_{IMPLANT} of the dental implant 92. The most common length of the sub-collar L_{SUB-COLLAR} is 0.5 mm which would be 5 percent of the length of a for example 10 mm length dental implant. However, it can be of any length and various lengths when multiple are added. In this disclosure the length of the sub-collar L_{SUB-COLLAR} is 1 mm, which would be 10 percent of the length of e.g. a 10 mm length dental implant. This is for purpose of better understanding and ease of illustrating.

The apical part 94b has a length L_{APICAL} which is variable depending on the overall length of the dental implant 92; it starts right below the 1^{st} coronal sub-collar 786, 786a all the way to the apex of the dental implant.

Since the dental implant 92 can be of any type; the entire body 93 has threads 99 except in the L_{SUB-COLLAR} (FIGS. 1A, 1B) and L_{SUB-COLLAR-1, SUB-COLLAR-2, SUB-COLLAR-2} (FIGS. 2A, 2B) areas. The threads can have the same or different thread pitches (e.g. longitudinal distance between consecutive peaks, crest to crest distance, trough to trough distance) and/or the same or different thread depths. The threads 99 can run in a clockwise or an anticlockwise direction.

As shown in FIG. 1B i) and 1D i) the thread 99 anywhere in the body of the dental implant body (not in area L_{SUB-COLLARS}) has a thread depth td₁ for this specific disclosure. It is variable depending on where it is in the body, shape of the dental implant and manufacturer. In some implementations, the thread depth td₁ is between about 0.1 and 0.9 millimeters (e.g. 0.1, 0.2, 0.3, 0.4, 0.5, 0.6, 0.7, 0.8, 0.9 millimeters).

Whereas the thread 99 at the junction of the sub-collars has a depth of td₂. It is variable depending on the sub-collars inward indentation (FIG. 1B ii), outward protrusion (FIG. 1D iii) or it being flat (FIG. 1D ii); in relation to the the crests of the threads above and below it.

The second thread depth td₂ may be in a positive value 0.1, 0.2 etc. (indentation inwards FIGS. 1A, 1B, 2A, 2B, 3A and 3B), 0 (at the level of threads above and below FIG. 1C, 1D ii), 2C, 2D, 3C and 3D) or a negative value about −0.1, −0.2, etc. with outward protrusion shown in FIG. 1D iii). On a side note the outward protrusion does help in achieving greater torque and engagement of the implant with the bone. To make it easy for demonstration and understanding purposes the Figures are shown with the indentations first and than a flat sub-collar surface is shown. In one scenario the thread depth td₂ will be greater than the thread depth td₁ as the L_{SUB-COLLARS} do not have the threads rather are machined areas indented inwards (FIGS. 1A, 1B, 2A, 2B, 3A and 3B). In another scenario the thread depth td₂ is zero as the L_{SUB-COLLARS} are at the same level as the crest of the threads above and below the sub-collars with no indentations (FIGS. 1C, 1D, 2C, 2D, 3C and 3D). Various other thread depths are contemplated. In some implementation the thread depth td₁ is between 0.1 and 0.5 millimeters and thread depth td₂ is between about 0.5-0.9 millimeters. However, all these are variable.

The body 93 includes one or more vertical or non-vertical flutes (not shown). The flutes aid in self-tapping of the dental implant 92. This is necessary to get a greater torque as the torque is decreased by the addition of one or more intermittent turned/smooth/machined/hybrid sub-collar/s (Rezaa Ring/s) feature/s 786 (and 786a, 786b and 786c in FIGS. 2, 3, 4, 5 and 6).

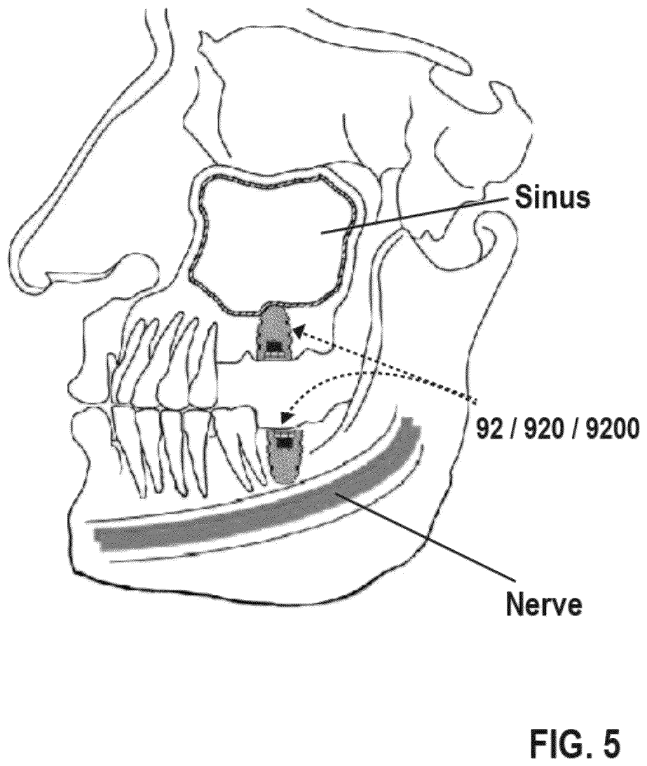

The dental implant 92/920/9200 has an overall length L_{IMPLANT}. The shortest dental implant may start from 5 mm up. The length of the dental implant L_{IMPLANT} to be placed is dependent on many factors; one of the most important is the location in which the dental implant 92 is being placed in the mouth. More specifically the anatomical structures i.e. inferior alveolar nerve, sinus (FIG. 5), etc. that cannot be moved for some reason.

The dental implant 920/9200 (FIGS. 2A, 2B, 3A and 3B) is similar to the dental implant 92 (FIG. 1A, 1B), except that the dental implant 920/9200 has three intermittent turned/smooth/machined/hybrid sub-collars (Rezaa Rings) features 786a, 786b and 786c in the body 930/9300 as compared to only one sub-collar (Rezaa Ring) 786 of the dental implant 92 (FIG. 1A, 1B). Each of the sub-collars (Rezaa Rings) features 786a, 786b and 786c are the same as, or similar to, the sub-collar 786. All these sub-collars (Rezaa Rings) are indented inwards. The similarities of the dental implants in FIGS. 1C, 1D, 2C, 2D, 3C and 3D is that the sub-collars features 786, 786a, 786b and 786c are flat (non indented). It is to be noted that a specific distance must be kept between the sub-collars feature/s 786.

Additionally, the first 786a, the second 786b and third sub-collar 786c can be the same as each other or different from each other (e.g. same diameters, same lengths, same curvatures etc. or any combination thereof). For example, in FIGS. 2A and 2B, the first sub-collar 786a is of a wider outer diameter D_{SUBCOLLAR-1}, and is more coronal than the second sub-collar 786b D_{SUBCOLLAR-2}. The third sub-collar 786c is apical to the second sub-collar 786b and its diameter D_{SUBCOLLAR-3} is less than that of D_{SUBCOLLAR-2}. This is in a case of a tapered dental implant as shown in the current disclosure. In a parallel walled dental implant, the diameters of the sub-collars (D_{SUB-COLLAR-1, 2 AND 3}) will be the same throughout the dental implant. This differs based on the type and shape of the dental implant.

Many other combinations of different sizes, numbers and locations of the intermittent turned/smooth/machined/hybrid sub-collar/s (Rezaa Ring/s) features 786a, 786b and 786c are contemplated. For example, in some such alternatives the length L_{SUBCOLLAR-1}, of the first sub-collar (Rezaa Ring) feature 786a can be less than or greater than the length L_{SUBCOLLAR-2} of the second sub-collar (Rezaa Ring) feature 786b and L_{SUBCOLLAR-3} of the third sub-collar (Rezaa Ring) feature 786c. The length can range from 0.1-2.5 mm. In some implementations the length L_{SUBCOLLAR-1, 2, 3} of the intermittent turned/smooth/machined/hybrid sub-collars (Rezaa Rings) features 786a, 786b and 786c is about 5%-30% of the overall length of the dental implant. In some other implementations it may be less than 5 percent or greater than 30 percent of the overall length of the dental implant.

According to some alternative implementations, the dental implant of the present disclosure can include any number of intermittent turned/smooth/machined/hybrid sub-collar/s (Rezaa Ring/s), such as, for example, one sub-collar as shown in (FIGS. 1A, 1B, 1C and 1D), Two sub-collars (not shown), three sub-collars (FIGS. 2A, 2B, 2C and 2D), Four sub-collars (not shown) etc. In such alternatives, each of the sub-collars can have the same or different size (e.g. maximum diameter, length, depth etc.) Further the positioning of the sub-collars can vary for example, in some implementations, specifically of the most common tapered dental implant used by most implant placing clinicians the first sub-collar has a maximum diameter, the second middle sub-collar has the second maximum diameter, meaning the diameter is smaller than the first sub-collar. The diameter of the third sub-collar is smaller than the second and obviously the first sub-collar; it's the lowest apical most sub-collar in a tapered dental implant. For another example in some implementations such as a short dental implant or one with variable shapes, the diameter of the sub-collars will be variable depending on its location on that specific dental implant. In a parallel walled dental implant, the sub-collars will have a constant diameter.

FIG. 3A is a perspective view of a dental implant 9200 that in addition to the three intermittent turned/smooth/machined/hybrid sub-collar/s (Rezaa Ring/s) features 786a, 786b and 786c; a collar 14 is positioned above the coronal part 9400a of the body 9300 of the dental implant 9200. The collar 14 is not threaded (e.g. the thread 9900 is not wrapped around the collar 14) and has a generally smooth outer surface not meant to osseointegrate (Sₐ 0.1-0.3 μm) as seen in a Tissue level dental implant (FIGS. 3A, 3B, 3C and 3D). As seen in FIGS. 3B and 3D the collar 14 has a length L_{COLLAR}, which can be for example, between about 0.25 to about 3 millimeters or more. In some implementations the length L_{COLLAR} of the collar 14 is about 5 percent to about 20 percent of the overall length L_{IMPLANT} of the dental implant; although this is variable. The collar may be of the same diameter as the outer diameter of the coronal part D_{CORONAL} or it may be wider (demonstrated in this disclosure). The dental implant 92 in FIGS. 1A, 1B, 1C and 1D and the dental implant 920 in FIGS. 2A, 2B, 2C and 2D) do not have a collar; the entire platform of both these dental implants 92 and 920 would embed in the bone when placing in patients. However, in FIGS. 3A, 3B, 3C and 3D a machined/smooth surface collar is demonstrated in a tissue level dental implant 9200. This collar is supposed to be present supra-crestal when placed in patients.

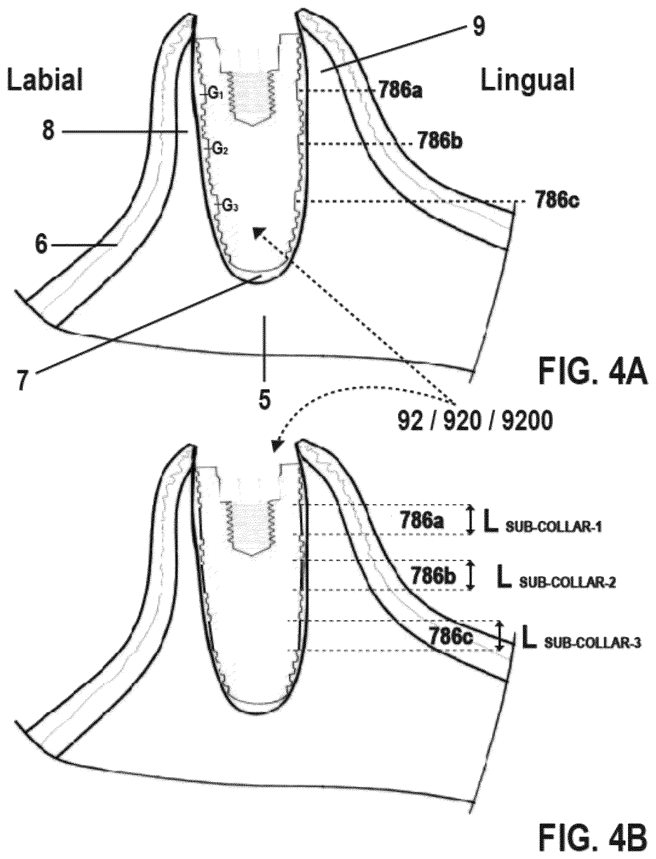

FIG. 4 is a cross sectional view of a mandible. It includes bone 5 and soft tissue 6 (e.g. gingiva) around a prepared osteotomy 7 (a implant drill is used to make a hole in the bone) with a dental implant 92/920/9200 installed therein. The bone 5 is relatively thin near the opening of the prepared osteotomy 7 and gets relatively thicker more apically into the prepared osteotomy 8. The bone on the labial side of the osteotomy 8 is usually thinner than the bone on the palatal side 9 of the osteotomy 7.

As such, in some scenarios it can be advantageous to encourage more bone growth on the labial side 7 by providing a greater gap G_{1,2,3} at the location of the intermittent turned/smooth/machined/hybrid sub-collar/s (Rezaa Ring/s) feature 786/786a/786b/786c of the installed implant by having indentations rather than having flat sub-collar/s (FIGS. 1A, 1B, 2A, 2B, 3A and 3B). The Gap G₁ is relatively constant around the L_{SUBCOLLAR} of the coronal part 94a. However, the gap G can vary depending on the implant manufacturing (how deep the indentation is) as well as the anatomy and immediate vs delayed implant placement. For example, the gap G_{1,2,3} may be about 1 mm adjacent to the labial side 7 and 0.5 mm adjacent to the palatal side 8. In the gaps G_{1,2,3} the blood clot fills in; as the intermittent turned/smooth/machined/hybrid sub-collar/s (Rezaa Ring/s) features 786/786a/786b/786c do not directly engage the prepared osteotomy.

In an opposing situation when there is no gap G_{1,2,3} between the location of the intermittent turned/smooth/machined/hybrid sub-collar/s (Rezaa Ring/s) feature 786/786a/786b/786c and the bone of the osteotomy due to the the sub-collars being flat; the sub-collars are in line with the crests of the threads above and below the sub-collars (FIGS. 1C, 1D, 2C, 2D, 3C and 3D).

In addition to the above scenarios in certain situations for obtaining better torque and better engagement of the dental implant with the bone or any other reason the sub-collar/s will be extended slightly outwards. This will in addition to increasing the torque value would putting less stress on the bone being the sub-collar surface is smooth and non threaded.

After the dental implant has been inserted in the osteotomy, a component (not shown) is screwed over the dental implant 92/920/9200. This can be a cover screw or any of the various abutments.

While the present disclosure has been described with reference to one or more particular embodiments and implementations, those skilled in the art will recognize that many changes may be made thereto without departing from the confines of the present disclosure. Each of these embodiments and implementations and obvious variations thereof is contemplated as falling within the spirit and scope of the present disclosure, which is set forth in the claims that follow.

What is claimed is:

1. This dental implant has surface modifications with the addition of one or more intermittent turned/smooth/machined/hybrid sub-collar/s (Reza ring/s) feature/s 786/786a/786b/786c. In this present invention disclosure for ease of demonstration one to three sub-collars are considered only. The first one is several millimeters below the platform, another sub-collar approximately midway about 5 mm below the platform (considering a 10 mm dental implant) and a third one a few millimeters above the apex. The exact locations and the height of the sub-collars can be modified to variable locations and heights respectively. It needs to be emphasized that the surfaces of these machined sub-collars of the dental implants do help in promoting bone growth during the healing after being placed.

2. This specific dental implant with the intermittent turned/smooth/machined/hybrid sub-collar/s (Rezaa Ring/s) features 786/786a/786b/786c will halt or slow the progression of the peri-implantitis, allowing time and opportunity for the clinician to treat the peri-implantitis or refer to treat. Once you start to loose osseointegration starting from the coronal third you arrive at this turned/smooth/machined/hybrid sub-collar (Rezaa Ring) 786/786a. This is a smooth non threaded surface that if exposed as a result of Peri-implantitis, it is a site where plaque accumulation is minimal. It will also at the same time allow better ability to clean. In other words for peri-implantitis treatment a smooth surface is always preferred to work with rather than a rough threaded surface.

3. The intermittent turned/smooth/machined/hybrid sub-collar/s (Rezaa Ring/s) feature/s 786/786a/786b/786c on this dental implant will allow the bone to remain stable for some time immediately below the sub-collar at the junction of the machined (non-blasted) and rough (blasted) surfaces. This is critical in specifically in those patients that have Zygomatic implants, Bulky hybrid restorations with multiple dental implants, or those patients that are unable to afford treatment of Peri-implantitis for the short term. In summary, those areas/sites with limited access for cleansability.

4. The intermittent turned/smooth/machined/hybrid sub-collar/s (Rezaa Ring/s) feature/s 786/786a/786b/786c have a flat machined surface (indentation or in line with threads above and below) making it easier to treat peri-implantitis as opposed to having threads completely throughout from the top coronal to the apex. The first turned/smooth/machined/hybrid sub-collar (Rezaa Ring) feature is to be placed approximately 3.5 mm below the platform, which is a very accessible distance for instruments to reach when needed for treatment of peri-implantitis.

5. When treating peri-implantitis one of the two approaches are followed. If a regenerative approach is taken into account the prognosis after treatment is improved due the presence of smooth non threaded surface in the areas of the sub-collars. When the regenerative approach is not possible, a respective approach for treatment is undertaken. Everything above the sub-collar will become supracrestal and the polished surface of the sub-collar will become the next sulcus for epithelium.

6. One very important scenario that will be commonly utilized within the sub-collar/s feature is a combination of machined (Sₐ 0.3-1.0 μm) and polished surfaces (Sₐ 0.1-0.3 μm). Each sub-collar will be divided into the top ⅔^{rds} that has a machined surface with a Sₐ value between 0.3-1.0 μm and lower ⅓^{rd} that has a polished surfaces with a Sₐ value between 0.1-0.3 μm. Clinically the sub-collar will look the same throughout but transition zone will be visible under an electron microscope. This will provide that sudden halt of bone progression right below the non integratable lower ⅓^{rd} of the sub-collar/s. By dividing each sub-collar into an upper ⅔^{rd} and a lower ⅓^{rd} osseointegration is not compromised as the machined surfaces promote bone growth.

7. The intermittent turned/smooth/machined/hybrid sub-collar/s (Rezaa Ring/s) feature/s 786/786a/786b/786c serve as a demarcation surface visible on the radiograph, providing a guideline for the clinician to either treat or refer to be treated by another clinician for advanced treatment.

8. The intermittent turned/smooth/machined/hybrid sub-collar/s (Rezaa Ring/s) feature in this implant design is helpful in patient education to help understand the importance of hygiene and potential bone loss, and when to get treatment. This demarcation will intrigue the thought process in the viewers (patient or clinician) mind; hence initiate a self-understanding of both by the clinicians as well as patients. This will also be helpful for explanation purposes during informed consent too; which is often forgotten. Also, the advertisement makes it sound like implants are bullet proof. This will help viewers to understand more; hence make intelligent decisions.

9. The addition of a third intermittent turned/smooth/machined/hybrid sub-collar (Rezaa Ring) feature about 3.5 mm above the apex indicates to the dentist and the patient that the implant has a poor prognosis and possibly needs explanation. It will also provide the patient a better understanding of the prognosis. In addition it will also allow any clinician to do a better explanation of the outcomes to those patients who are persistent in choosing to treat the dental implant at that point.

10. The intermittent sub-collars 786/786a/786b/786c are much less rough (±0.5 μm), as compared to the remaining dental implant (1.0-2.0 μm), which will make it easier to remove an ailing dental implant when indicated as a lesser level of osseointegration is achieved on the sub-collars portions due to the less bone-to-implant contact.

11. The height of each sub-collar will range from 0.1-1.5 mm or more depending not only on the primary objective of halting or slowing the rate of peri-implantitis but also on the level at which it will appear on the radiograph and at the same time; not have it compromise with the surface area of osseointegration needed for implant success.

12. These sub-collar modifications will be utilized on all types of dental implants be it bone level, tissue level, external or internal hex; regardless of dental implant surfaces.

13. These dental implants with the sub-collars will be used for all patients. If a choice is to be made regarding its use in some patients for any reason; those at high risk for peri-implantitis are prioritized; putting a brake on the progression of Peri-implantitis. Some examples of possible high-risk patients are smokers, history of periodontitis, history of peri-implantitis, diabetes, patients with poor oral hygiene, etc. Although it should be made clear that dental implants with these sub collars do not give the license to a clinician to place them in high risk patients; rather the high risk factors should be controlled.

14. All in all; the mere presence of these backup features (intermittent turned/smooth/machined/hybrid sub-collar/s (Rezaa Ring/s) 786/786a/786b/786c; will increase the success and the survival rate of dental implants.
